(19) United States
(12) Patent Application Publication
(10) Pub. No.: US 2017/0036958 A1
(43) Pub. Date: Feb. 9, 2017

(54) ENVIRONMENT-FRIENDLY ARTIFICIAL MARBLE WITH COFFEE SCENT USING BREWED COFFEE POWDER AND COFFEE BY-PRODUCTS AND METHOD FOR MANUFACTURING SAME

(71) Applicants: Kang Young Cho, Anseong-si Gyeonggi-do (KR); WORLD CMMA CO. LTD., Jincheon-gun Chungcheongbuk-do (KR)

(72) Inventors: Kang Young Cho, Anseong-si Gyeonggi-do (KR); Guk Tae Kim, Cheongju-si Chungcheongbuk-do (KR); Sang Hyun Lee, Jincheon-gun Chungcheongbuk-do (KR); Jin Su Yeo, Cheungju-si Chungcheongbuk-do (KR); Ju Do Eom, Cheungju-si Chungcheongbuk-do (KR)

(21) Appl. No.: 15/304,521

(22) PCT Filed: Apr. 17, 2014
(86) PCT No.: PCT/KR2014/003371

§ 371 Date: Oct. 15, 2016

(51) Int. Cl. C04B 18/24; C04B 14/30; C04B 16/06; C04B 26/06

(52) U.S. Cl. CPC C04B 18/24; C04B 26/06; C04B 14/303; C04B 16/0641; C04B 2111/545

(57) ABSTRACT

Disclosed are: an environment-friendly artificial marble which can release a coffee scent and shows a pleasing natural aesthetic by adding ground brewed coffee or coffee by-products, which are the grounds discarded when coffee is made with coffee powder or brewed coffee and the like, during the manufacture of an artificial marble; and a method for manufacturing the same. The present invention relates to an artificial marble comprising, in addition to normal additives, coffee grounds or ground brewed coffee of 10 to 100 wt parts based on an unsaturated polyester resin of 100 wt parts, and the present invention provides the advantages of: being environment-friendly since glass fiber is not used during the manufacture of the artificial marble; recycling resources and also protecting the environment by utilizing coffee grounds discarded as waste for the manufacturing of the artificial marble; exhibiting a more natural texture due to the color of the coffee itself; showing a healing effect for the human body due to the scent of the coffee; and saving other ingredients by adding the coffee grounds, thereby being more economical, remarkably environment-friendly, and having good texture.

### BACKGROUND OF THE INVENTION

Field of the invention

The invention relates to an artificial marble and a method for manufacturing the same, and more particularly, an environment-friendly artificial marble which can release a coffee scent and shows a pleasing natural aesthetic by adding ground brewed coffee or coffee by-products, which are the grounds discarded when coffee is made with coffee powder or brewed coffee and the like, during the manufacture of an artificial marble; and a method for manufacturing the same.

Related Art

Natural stones such as marble or granite have been extensively used as building vanities from old times due to a beautiful surface pattern. Recently, the demand for the natural stones is increasing significantly in various fields such as floorings, walls, countertops as materials representing high quality texture. However, since the natural stones are expensive, only natural stones are not able to meet the demand so that various types of artificial stones expressing the natural texture have been developed.

The artificial marble as described above may be classified into a generally artificial marble made by adding an inorganic filler and various mixing materials to an unsaturated polyester resin or acrylic resin and a resin based reinforced artificial stone representing the natural texture by vibration compression molding a compound obtained by mixing an inorganic-based natural mineral with a binder resin.

The above artificial marble is mixed with a binder resin such as an unsaturated polyester resin or an acrylic resin, the inorganic filler, inorganic-based strength reinforcing glass fibers, marble color chips according to the purpose and the function, and other additives such as pigments or dyes. Since the artificial marble using the above has electrical insulating properties, heat resistance, chemical resistance, and the like, the artificial marble has been variously used in the field of electrical insulating materials in addition to the wall and the flooring.

However, since glass fibers are used in the above artificial marble, the use of the artificial marble is avoided for a kitchen such as built-in finishing materials or a sink.

Accordingly, various approaches have been pursued in the art to solve the above problems and to provide an environment-friendly artificial marble. An artificial marble having a natural pattern and a partial luminescent, and a method of manufacturing the same are disclosed in Korean Patent Publication No. 10-2013-0077680. An apparatus for forming an artificial stone, a method of forming an artificial stone, and an artificial stone manufactured therefrom are disclosed in Korean Patent Registration No. 10-0980802. Various other artificial marbles and a method for manufacturing the same are disclosed, but are completely different from the spirit and scope of the present invention.

On the other hand, coffee is the popular drink which everybody enjoys. Accordingly, and a variety of coffee makers and coffee shops have been increased. Particularly, a coffee beans market using coffee beans has been increased.

As described above, as the coffee market is increased, coffee grounds being byproducts remaining after the manufacture of coffee are also increased. The coffee grounds are used only for an air freshener or deodorant due to scent. Most coffee grounds are discarded to adversely affect an environment. Accordingly, there is a need for a method of recycling the coffee grounds.

According to the need, technologies using the coffee grounds are described. A method for manufacturing a functional pulp and paper from coffee grounds is disclosed in Korean Patent registration No. 10-1257214. An article such as construction furniture panels, frames, and dolls manufactured using coffee grounds is disclosed in Korean Patent publication No. 10-2004-0051186. A soap using coffee grounds and a method of manufacturing the same are disclosed in Korean Patent publication No. 10-2012-0081293. Coffee grounds used in bio-plastic are disclosed in Korean Patent publication No. 10-2013-0083472. A teaching tool with used coffee grounds is disclosed in Korean Utility model publication No. 20-2012-0001902. Effective extracts used as bio oils, cosmetics, or medical materials from coffee grounds and a method of manufacturing the same are disclosed in Korean Patent publication No. 10-2011-0077722. A deodorant using coffee grounds is disclosed in Korean Patent publication No. 10-2013-0019820. A disposable container using coffee grounds and a method of manufacturing the same are disclosed in Korean Patent publication No. 10-2013-0109300.

However, the prior arts as described above using the coffee grounds are fundamentally different from the scope and spirit of the invention.

### SUMMARY OF THE INVENTION

The present invention provides an artificial marble using brewed coffee powder or coffee by-products which allows the recycling of waste resources and represents a natural texture of marble by utilizing waste coffee grounds or ground brewed coffee (hereinafter referred to as ‘coffee grounds’) that may pollute the environment in an environment-friendly artificial marble and stabilize modern people upon being used in a building by generating a subtle coffee scent, and a method for manufacturing the same.

In accordance with an aspect of the present invention, there is provided an artificial marble including thermoplastic low profile agent of 10 to 100 wt parts, an inorganic filler of 200 to 300 wt parts, a color chip of 10 to 100 wt parts, a reinforcing material of 5 to 100 wt parts, a curing catalyst of 0.1 to 5 wt parts, a release agent of 5 to 30 wt parts, a pigment of 0 to 30 wt parts, and coffee grounds of 10 to 100 wt parts based on an unsaturated polyester resin or an acrylic resin of 100 wt parts.

In accordance with an aspect of the present invention, there is provided a method for manufacturing an artificial marble, the method including: mixing thermoplastic low profile agent of 10 to 100 wt parts with a curing catalyst of 0.1 to 5 wt parts based on an unsaturated polyester resin or acrylic resin of 100 wt parts (S1); mixing coffee grounds or ground brewed coffee with the mixture in the step S1 (S2); mixing an inorganic filler of 200 to 300 wt parts, a color chip of 10 to 100 wt parts, and an internal release agent of 5 to 30 wt parts with the mixture in the step S2 (S3); adding an reinforcement material of 5 to 100 wt parts and a thickener of 0.1 to 2 wt parts to the mixture to heat the mixture after step S3 (S4); and aging and forming the mixed mixture (S5).

The present invention further provides a method of processing coffee grounds or ground brewed coffee, the method including: drying collected coffee grounds or ground brewed coffee only to have moisture content of 45 to 55% under 70 to 100° C. dry condition (SS1); and classify the dried coffee grounds or ground brewed coffee of 10 meshes (SS2).

### EFFECTS OF THE INVENTION

The present invention may provide an artificial marble with the advantages of: being environment-friendly since glass fiber is not used during the manufacture of the artificial marble; recycling resources and also protecting the environment by utilizing coffee grounds discarded as waste for the manufacturing of the artificial marble; exhibiting a more natural texture due to the color of the coffee itself; showing a healing effect for the human body due to the scent of the coffee; and saving other ingredients by adding the coffee grounds, thereby being more economical, remarkably environment-friendly, and having good texture.

### DESCRIPTION OF EXEMPLARY EMBODIMENTS

Hereinafter, exemplary embodiments of the present invention will be described in detail. It will be understood by those skilled in the art that various changes in form and details may be made therein without departing from the spirit and scope of the invention as defined by the appended claims.

The present invention provides an artificial marble including coffee grounds or ground brewed coffee of 10 to 100 wt parts based on an unsaturated polyester resin of 100 wt parts, in addition to an unsaturated polyester resin or acrylic resin or various additives.

The additives may include at least one selected from the group consisting of a low profile agent, inorganic fillers, color chips, a reinforcing material, a curing catalyst, and a release agent.

First, Constituent elements used in the present invention will be described.

In general, a synthetic resin-based artificial marble includes unsaturated polyester resins and acrylic resins.

The artificial marble of the molding method of applying unsaturated polyester resins or acrylic resins has been extensively used in the construction kitchen and the interior design. Since the artificial marble of the molding method has excellent performance, a resin having viscosity of 20 to 50 Poise/25° C., and non-volatile content (solid content) of 55% to 70% is appropriate for a liquid resin such as unsaturated polyester resins or acrylic resins and is selected by taking into consideration gloss, bending, breakage, and the like of the molded article in the present invention.

In the present invention, normal items listed in a following table 1 with respect to the resin of 100 wt parts were used.

TABLE 1

| Resins | Items | Characteristics |
|---|---|---|
| Unsaturated | MP012 (Tere)/ | For artificial marble, |
| PolyesterResin | MP712 (HBPA) | high gloss, weatherproof |
| (UPR) | AP7200 (Tere)/ | For artificial marble, |
| | AP5500 (HBPA) | high gloss, weatherproof |
| PolyesterResin | SW-5011 | For artificial marble |
| (UPR) | | |

Then, a low profile thermoplastic resin is used to prevent shrinkage.

The low profile agent is used in order to prevent shrinkage and includes about 10 to 100 wt parts based on the unsaturated polyester resin or acrylic resin of 100 wt parts by weight.

Hereinafter, except for the unsaturated polyester resin, wt parts of constituent elements according to the present invention are indicated based on the polyester resin or the acrylic resin of 100 wt parts.

A type of a thermoplastic low profile agent may include products having components of Polystyrene (PS) and Polyvinylacetate (PVAc). The unsaturated polyester resin or the acrylic resin is cured to accompany the volume shrinkage of 7 to 10%. The low profile agent significantly prevents the shrinkage to represent low contractility. The shrinkage of the molding artificial marble is reduced to less than 0.2%.

However, the used optimum amount is obtained by taking into consideration excellent product appearance such as the shape of the artificial marble, a material curing rate, a molding temperature, and molding pressure. That is, the anti-shrink function is significantly reduced in a profile agent of 10 wt parts or less, and a low profile agent floats on a surface of the artificial marble in a profile agent of 100 wt parts or more to make the surface cloud so that transparent texture is degraded. Accordingly, the above-described range is used.

A following Table 2 shows types of low profile agents which may be used in the present invention.

TABLE 2

| Type of low profile | | |
|---|---|---|
| agent | Product Name | Characteristics |
| PS based(poly | L-01, APS50, PS40 | Colorability, |
| styrene) | | flowability |
| PE based | UF20, UF80 | Smoothness, |
| (polyethylene) | | flowability |
| PVAc-based | L73, L75 | Dimensional |
| (polyvinylacetate) | | stability, |
| | | compatibility |

Then, the inorganic filler of 200 to 300 wt parts is used.

A filler is used in order to increase the dimensional stability, precision, and surface smoothness of a molded article. It is preferred to use aluminum hydroxide as the filler. An inorganic filler applied to architectural molding compound based artificial marble includes aluminum hydroxide Al(OH)₃. However, in a special case, an inorganic filler of a silica component may be used. In the case of using the silica component, there is a need for special equipment. Accordingly, it is difficult to apply the inorganic filler of a silica component to a field of a molding compound based artificial marble a little. There are various types of aluminum hydroxide being the inorganic filler by manufacturing countries, by particle sizes, by colors (ultra white), and by prices. A ultra-white product (Japan: H-320, H32) having excellent transparency and flowability and with stabilized mold is extensively used.

In the present invention, if the amount of the inorganic filler is increased, the dimensional stability is increased but the physical properties (mechanical strength) are reduced. If a specific gravity of the inorganic filler is increased, the handling is inconvenient and brittle is lowered. If the specific gravity of the inorganic filler is insufficient, the dimensional stability becomes unstable and a product is modified. Accordingly, the transparent texture reduces the role, the range as described above is preferable, and the present invention uses the types listed in Table 3.

TABLE 3

| | Product | |
|---|---|---|
| Types | Name | Characteristics |
| ATH(Al(OH)₃) | H32, | Particle size (8 to 25 μm)/ |
| (Aluminum | H320, | dimensional stability/ |
| Trihydroxide) | H10 | flame retardant property/ |
| | | transparency |

Then, a color chip or a UP chip of 10 to 100 wt parts expressing the texture of a natural stone is used.

The color chip expresses texture patterns of the natural stone by crushing and classifying a molding which is obtained by mixing unsaturated polyester, aluminum hydroxide, curing agent, and pigment to cure to white, black, yellow, brown, and the like. The amount of the color chip contains generally about 10 to about 100 wt parts. However, if the color chip is excessively used, the flow of a material in the mold during the molding may be prevented. If the amount of the color chip is used too little, since the chip is concealed in a color of the material color to reduce the texture of the marble, the above range is determined. In the present invention, in order to achieve the object of the present invention, the coffee grounds are classified and used. Accordingly, the brown color chip is alternatively used so that the brown color chip may be inevitably used.

Chips that can be used are listed in Table 4.

TABLE 4

| | | Particle size | |
|---|---|---|---|
| | | according to | |
| UP CHIP | Color | mesh | Precautions |
| UP COLOR CHIP | WHITE | 6/6~10/10~18/ | Surface scratch of |
| (for pattern of | BROWN | 18~30/30~100 | product surface |
| artificial | YELLOW | | uneven mold, |
| marble | BLACK | | backlash phenomenon |

In addition, polyvinyl alcohol fibers (Poly vinyl alcohol fiber being organic fiber of 5 to 100 wt parts is used as a reinforcement material.

The use of the reinforcement material represents the effect of increasing mechanical strength of the product and improving cracking and the dimensional stability of the molded product, due to the matric flow in the mold. The reinforcement material of the molding compound generally uses glass fiber (6 mm, 12 mm). However, an organic fiber is used for the artificial marble to achieve the object of the present invention. It is known that the organic fiber cannot be used because the use of the organic fiber significantly reduces the physical properties of the artificial marble and increases shrinkage to cause crack deformation of the product. In the present invention, it has also been found that the organic fiber has sufficient strength and has the texture of the artificial marble better than the glass fiber by adjusting the process. The above range is determined because the mechanical properties is reduced to be difficult to be used as the artificial marble in 5 wt parts or less, and the organic fiber is absorbed in a resin material not to mix materials in 100 wt parts or more. Used fibers are listed in a following table 5.

TABLE 5

| | Type of organic | |
|---|---|---|
| Organic fiber | fiber | Characteristics |
| Type of | Poly vinyl alcohol | Although there are |
| organic fiber | fiber | several organic fibers, |
| | Nylon fiber | organic fiber is firstly |
| | Polypropylene | adopted as reinforcement |
| | fiber | material of the |
| | Polyester fiber | artificial marble in the |
| | | world |

Also, a curing catalyst of 0.1 to 5 wt parts is used.

The curing agent uses an organic peroxide. Since the molding compound based artificial marble is typically formed in the range of about 130° C. to 140° C., a Tert.Butylperoxybenzoate (TBPB) is a yellow liquid, and is an organic peroxide having a —OO— bond in the molecule. The curing agent serves as high-temperature curing agent for the unsaturated polyester resin (UPR), or as an EPS and acrylic resin polymerization initiator. Since the curing agent exerts influence upon the productivity the appearance of the product, the curing agent should be carefully selected.

Excessive or insufficient use or the curing agent damages the product or the product is not formed which results in causing great problems on the exterior so that the catalyst having the above range is shown in the following Table 6.

TABLE 6

| | | Half-life | Purposes by |
|---|---|---|---|
| Types | Chemical names | (10 hr) | molding methods |
| TBPB | t-Butyl peroxybenzoate | 104° C. | Artificial |
| | | | marble |
| TBPB | t-Butyl isopropyl | 99° C. | Electrical |
| | monoperoxycarbonate | | product |
| TBPO | t-Butyl peroxy-2- | 77° C. | Cold molding |
| | ethylhexanoate | | |

Then, an internal release agent of 5 to 30 wt parts is used.

The release agent is used to efficiently separate a molded article from the mold to prevent the mold from being damaged and to improve an appearance of the molded article.

The general release agent includes a type of release agent which is buried in a material and is erupted outward during molding and a type of release agent which pastes on a surface of the molding by burying a liquid release agent in a piece of cloth. An internal release agent is used in the case of the molding compound. If the internal release agent is excessively used, yelling of the molded article easily occurs and a surface is softened. When the internal release agent is insufficiently used, the molded article is stuck to the mold to damage a produce and the mold so that the above-described range is determined.

The release agents used are listed in the following Table 7.

TABLE 7

| Types of | Melting | | |
|---|---|---|---|
| internal | point | | Purpose/ |
| release agent | (° C.) | Appearance | characteristics |
| Aluminium | 140 to 150 | White powder | For molding |
| stearate | | | compound |
| Zinc stearate | 115 to 125 | White powder | For molding |
| | | | compound |
| Calcium | 140 to 145 | White powder | For molding |
| stearate | | | compound |

Then, the pigment of 0 to 30 wt parts may be used.

Pigments are used to represent the color required by customers. However, there are various types of pigments. The pigments include an inorganic pigment and an organic pigment. Pigment in conflict with the RoHS item environmentally detrimental so that the use of the pigment is prohibited. Thus, it is significantly difficult to select the pigment. If the pigment is particularly used in mixing colors of the artificial marble, it is preferable to use the pigment after confirming RoHS test results and MSDS. According to the type of the pigment, some pigments may serve to promote or delay the curing so that a sufficient test is required. In some cases, the white color is mainly used for a titanium oxide (TiO₂)

The pigment may not be used in the present invention. The pigment of 30 wt parts is preferably used.

The reason for this is because sense of a marble may be degraded because the color chip and the transparent texture are concealed due to the pigment.

And, in the present invention, an inorganic filler and color chips UP, and a brewed coffee ground of 10 to 100 wt parts being a coffee by-product instead of the pigment are used.

In the present invention, by using the above UP color chip and the inorganic filler, and a brewed coffee ground pre-processed to be used instead a part of the pigment, so that the pigment is not used at all in order to achieve the object of the present invention. If the pigment is used, a color chip and the like are concealed so that the artificial marble has a rough surface even if the same amount is used. The surface of the artificial marble provides more beautiful and luxurious texture by using the pre-processed brewed coffee ground. Since coloring is difficult in 10 wt parts or less and the fluidity of the material in the mold is significantly reduced in 100 wt parts or more to generate stain, the above-described range is determined.

In addition, in order to improve impregnation of the other materials, additives of surfactant component may be used. The additives improve physical properties by improving compatibility with the organic material and the inorganic material, which mainly uses BYK Co., in German.

In order to delay a cure rate, a retarder of the quinone (quinone: US Eastman corporation) based component may be used. MgO (magnesium oxide) of 1% based on the resin may be used as thickener to facilitate handling of a material. A content of MgO is 0.5% or less being 50% level of the resin in order to achieve the object of the present invention. The reason for this is that the fluidity of a material is increased so that one-pointedness of a resin occurs if the Mg0 is not used. If an amount of MgO is too great, the material is solidified so that the flowability of the material is slow. Gas and non-molded part are generated on a surface of a molded article due to early gelation. The reason is why the raw material should be excessively provided in order to improve this.

For the above reason using the above constituent elements, the present invention provides an artificial marble including thermoplastic low profile agent of 10 to 100 wt parts, an inorganic filler of 200 to 300 wt parts, a color chip of 10 to 100 wt parts, a reinforcing material of 5 to 100 wt parts, a curing catalyst of 0.1 to 5 wt parts, a release agent of 5 to 300 wt parts, and coffee grounds or a brewed coffee powder of 10 to 100 wt parts based on an unsaturated polyester resin or acrylic resin of 100 wt parts.

The present invention may further include a pigment of 30 wt parts, and may include a surfactant, a cure rate retarder, a thickener, and the like.

Constituent elements of the above constituent elements except for the coffee grounds may be selected from those which are available in the normal method of manufacturing the artificial marble.

The present invention further provides a method for manufacturing an artificial marble includes: mixing thermoplastic low profile agent of 10 to 100 wt parts with a curing catalyst of 0.1 to 5 wt parts based on an unsaturated polyester resin or acrylic resin of 100 wt parts (S1); mixing by-products being coffee grounds with the mixture in the step S1 (S2);

mixing an inorganic filler of 200 to 300 wt parts, a color chip of 10 to 100 wt parts, and an internal release agent of 5 to 30 wt parts with the mixture in the step S2 (S3);

adding an reinforcement material of 5 to 100 wt parts and a thickener of 0.1 to 2 wt parts to the mixture to heat the mixture after step S3 (S4); and aging and forming the mixed mixture (S5).

The mixing in the step S1 is performed in a range of 25° C. to 30° C. for 15 to 20 minutes. The reason for this is that the mixing is difficult if a temperature is too low and a time is too short, and there are no effects longer if the temperature is too high and the time is too long in order to optimize mixing the filler with an organic fiber being a reinforcement material.

It is preferable that the mixing is performed for 15 to 20 minutes and the mixing temperature is in a range of 30° C. to 35° C. in the step S2.

It is preferable that the mixing is performed for 15 to 20 minutes and a temperature of the mixture is in a range of 35° C. to 40° C. in the step S3. The reason for this is that mixing with the inorganic fiber being the reinforcement material is optimal when a viscosity of the mixture ranges from 5,000 to 10,000 Poise, and it is optimal so that the viscosity of the mixture becomes the above range in the above temperature and time.

It is preferable that the mixing is performed for 5 to 10 minutes and a temperature of the mixture is in the range of 40° C. to 45° C. in the step S4. The reason for this is that the viscosity of the mixture is rapidly increased to 100,000 Poise if an organic fiber being a reinforcement material is mixed, the organic fiber is not sufficiently impregnated during mixing below the above temperate and time ranges, and a temperature of the material is increased to deteriorate the storage stability of the mixture greater than the above temperate and time ranges.

Further, it is preferable that the aging in the step S5 is performed in the range of 20° C. to 25° C. cool dark condition for 24 to 48 hours. The reason for this is that the aging under the above condition maintains an optimal viscosity to flow in the mold to uniformize all physical properties of the molded article and so that the best texture of the artificial marble is expressed. The aging under the above condition is performed to make handling of the material easy. If the condition of the aging is beyond the above-mentioned range, it is difficult to satisfy the above condition.

Also, the forming in the step (S5) is also carried out by a conventional method for forming an artificial marble. That is, the forming in the step (S5) may be performed under the conventional condition for forming the artificial marble including 130 to 150° C., 1 min./thickness of molded article (mm), and a molding pressure condition of 90 to 150 kgf/cm². A specific gravity of the conventional artificial marble material is in the range of 1.7 to 1.9. However, it has been found that a specific gravity of the artificial marble material is in the range of 1.5 to 1.6 so that it is easy to handle in the present invention.

The present invention also provides a method of processing by-products which is coffee grounds in the artificial marble or a method of manufacturing the artificial marble.

The method of processing the coffee grounds includes drying the coffee grounds (generally moisture content of 45 to 55%) of collected brewed coffee (SS1); and removing impurities from the dried coffee grounds to classify the dried coffee grounds (SS2).

It is preferable that the moisture content has about 5% by drying in the range of 70 to 100° C. for about 6 to 8 hours in the drying in step SS1. The reason for this is that the flowability of the material in the mold is deteriorated so that all physical properties are deteriorated if the moisture content is equal to or greater than 5% and the most effective target moisture content is obtained within the above temperature and time.

Further, it is preferable to remove coffee grounds of a size having larger than 10 mesh in the classification in step SS2. The reason for this is that impurities are formed on a surface of the artificial marble to cause generation of a defective product if the coffee grounds of a size having larger than 10 meshes are not removed.

It can also be further subjected to an additional step of adding insufficient coffee scent in the processing method.

### Embodiment

An artificial marble is compounded using the processed brewed coffee grounds so that a molded article of the artificial marble is manufactured. In this case, the optimum conditions of the method for manufacturing the environment-friendly artificial marble are listed in a following table 8.

TABLE 8

| | Comparative | Comparative | |
|---|---|---|---|
| | example 1 | example 2 | Example |
| Unsaturated polyester | 70~80 | — | — |
| resin | | | |
| Unsaturated polyester | — | 70~80 | 70~80 |
| PMMA Hybrid resin | | | |
| Low profile agent of | 20~30 | 20~30 | 20~30 |
| thermoplastic | | | |
| components | | | |
| Inorganic filler | 200~220 | 200~220 | 170~200 |
| (aluminum hydroxide) | | | |
| Color chip of texture | 20~50 | 20~50 | 15~25 |
| of marble | | | |
| Reinforcement organic | 50~100 | — | — |
| fiber | | | |
| Reinforcement organic | | 10~20 | 10~20 |
| fiber (PVA fiber) | | | |
| Curing catalyst | 0.5~3 | 0.5~3 | 0.5~30 |
| Internal release agent | 5~10 | 5~10 | 5~10 |
| Pigments | 10~15 | 10~15 | — |
| Pretreated brewed | — | — | 30~50 |
| coffee grounds | | | |
| Other additives | 3 | 3 | 3 |

Applied materials use the above mentioned components.

In effects of the embodiment, if the artificial marble is formed using the pigment according to the related art, thermal color fading was accompanied in the molding process for 10 minutes at the molding temperature of 140 to 150° C.

For this reason, it is difficult to produce wood texture and brown color products. Even if wood texture and brown color products are produced, it is not uniform to have limitations in the color application.

Meanwhile, no color stain occurs in the molded article of the present embodiment. Products using the brewed coffee grounds may reduce the cost in the range of 10% to 20% by reducing amounts of an organic filler and a color chip which are expensive. In particular, it may be confirmed that subtle coffee scent is remained on a surface of the artificial marble.

1. An artificial marble using an unsaturated polyester resin or an acrylic resin, the artificial marble comprising:
coffee grounds or ground brewed coffee of 10 to 100 wt parts in addition to normal additives based on an unsaturated polyester resin of 100 wt parts.

2. The artificial marble of claim 1, wherein the additives comprise thermoplastic low profile agent of 10 to 100 wt parts, an inorganic filler of 200 to 300 wt parts, a color chip of 10 to 100 wt parts, a reinforcing material of 5 to 100 wt parts, a curing catalyst of 0.1 to 5 wt parts, and a release agent of 5 to 30 wt parts based on an unsaturated polyester resin or an acrylic resin of 100 wt parts.

3. The artificial marble of claim 2, wherein the thermoplastic low profile agent comprises at least one selected from Polystyrene (PS), PE and Polyvinylacetate (PVAc).

4. The artificial marble of claim 2, wherein the inorganic filler comprises aluminum hydroxide or silica, the reinforcing material comprises a polyvinyl alcohol fiber being an organic fiber, the curing catalyst comprises an organic proxide, and the release agent comprises an internal release agent.

5. A method for manufacturing an artificial marble of claim 1, the method comprising:
mixing thermoplastic low profile agent of 10 to 100 wt parts with a curing catalyst of 0.1 to 5 wt parts based on an unsaturated polyester resin or acrylic resin of 100 wt parts (S1);
mixing coffee grounds or ground brewed coffee with the mixture in the step S1 (S2);
mixing an inorganic filler of 200 to 300 wt parts, a color chip of 10 to 100 wt parts, and an internal release agent of 5 to 30 wt parts with the mixture after the step S2 (S3);
adding an reinforcing material of 5 to 100 wt parts and a thickener of 0.1 to 2 wt parts to the mixture to heat the mixture after step S3 (S4); and
aging and forming the mixed mixture (S5).

6. The method of claim 5, wherein the mixing is performed for 15 to 20 minutes, and a temperature of the mixture is lower than 30 to 35° C. in the step S2.

7. The method of claim 5, wherein the mixing is performed for 15 to 20 minutes and a temperature of the mixture is lower than 35° C. to 45° C. in the step S3.

8. The method of claim 5, wherein the mixing is performed for 5 to 10 minutes and a temperature of the mixture is lower than a range of 40° C. to 45° C. in the step S4.

9. The method of claim 5, wherein the aging is performed in a range of 20° C. to 25° C. cool dark condition for 24 to 48 hours in the step S5.

10. A method of processing coffee grounds or ground brewed coffee of claim 5, 4, the method comprising:
drying collected coffee grounds or ground brewed coffee only to have moisture content of 5% (SS1); and
classify the dried coffee grounds or ground brewed coffee of 10 meshes (SS2).

11. The method of claim 10, wherein the drying is performed in a range of 70° C. to 100° C. for 6 to 8 hours in the step SS1.
